(19) United States
(12) Patent Application Publication
(10) Pub. No.: US 2013/0007831 A1
(43) Pub. Date: Jan. 3, 2013

(54) BIT RATE ADJUSTMENT IN AN ADAPTIVE STREAMING SYSTEM

(75) Inventors: Zhenyu Wu, Plainsboro, NJ (US); LiHua Zhu, Plainsboro, NJ (US); Gad Moshe Berger, Dayton, NJ (US)

(73) Assignee: THOMSON LICENSING, Issy Les Moulineaux (FR)

(21) Appl. No.: 13/581,618

(22) PCT Filed: Mar. 2, 2011
(86) PCT No.: PCT/US2011/000408

§ 371 Date: Aug. 29, 2012

Related U.S. Application Data
(60) Provisional application No. 61/310,975, filed on Mar. 5, 2010.

(51) Int. Cl. H04N 21/45; H04N 21/25

(52) U.S. Cl. 725/116; 725/131

(57) ABSTRACT

A method and apparatus for adaptively streaming multiple video bit streams through a network node is disclosed. In particular, a system is taught where at least one of the video bit streams is scaled in response to a bandwidth limitation or availability, where the selection of the bit stream selected for scaling in made in response to at least one of a user defined, service provider defined, and usage analysis defined priority list.

### CROSS REFERENCE TO RELATED APPLICATION

This application claims priority to and all benefits accruing from a provisional application filed in the United States Patent and Trademark Office on Mar. 5, 2010 and assigned Ser. No. 61/310,975.

### FIELD OF THE INVENTION

The invention relates to a method and apparatus for adaptively streaming multiple video bit streams through a network node. The apparatus may be in the form of a set top box for use with multiple television displays or other viewing devices. More particularly, the invention concerns methods and apparatuses for adaptively streaming multiple video bit streams through a network node is disclosed. In particular, a system is taught where at least one of the video bit streams is scaled in response to a bandwidth limitation or availability, where the selection of the bit stream selected for scaling in made in response to at least one of a user defined, service provider defined, and usage analysis defined priority list.

### BACKGROUND OF THE INVENTION

The present invention generally relates to an apparatus and methods for streaming multiple video streams through a network node, where the network or network node has a limited bandwidth. The system is operative to adjust the bit rates of multiple video bit streams when the system has insufficient or extra bandwidth capacity. The methods and associated apparatus are suitable for use in a home, educational, or business environment where multiple video streams are networked and processed, and intelligent selection of playback quality for some video streams over other video streams is desired.

This section is intended to introduce the reader to various aspects of art, which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

In a network-based video streaming system, multiple video bit streams can share the bandwidth at a network node. It is possible that their aggregated bit rate either exceeds or is below the bandwidth capacity of the node. In the former case, network congestion can occur, which leads to packet drops or long packet delays. Playback quality can be severely impacted by those factors. In the latter case, the bandwidth resource is under utilization at the node and thus the viewing experience is not at its optimum.

Adaptive Bit rate Streaming (or Adaptive Streaming) is a technique used in streaming multimedia over computer networks. While in the past most video streaming technologies utilized streaming protocols such RTSP, today's adaptive streaming technologies are almost exclusively based on HTTP and designed to work efficiently over large distributed HTTP networks such as the Internet. It works by detecting a user's bandwidth and CPU capacity in real time and adjusting the quality of a video stream accordingly. It requires the use of an encoder which can encode a single source video at multiple bit rates. The player client switches between streaming the different encodings depending on available resources. Resulting in reduced buffering, fast start time and a good experience for both high-end and low-end connections.

An adaptive streaming system can address the above problem by informing the content servers to adjust the sending bit rates. Specifically, the node can reduce the bit rate of one or several video programs in case of bandwidth insufficiency, or increase the bit rate in the case of bandwidth surplus. Adaptive bit rate streaming systems work by determining a network node's bandwidth and adjusting the quality of the video stream in response to that determination. The system requires an encoder which can encode a single source video at multiple bit rates. The node requests or selects one of the different encodings depending on its available resources. This results in the desirable qualities of little or no buffering, fast start times, and optimal experience for both speed end and low speed connections.

In the case when the video bit streams all come from the same content server, the network node can inform the server and let it make the decision on which content to scale. Upon receiving the node's request, the server may also reallocate the available bit rate among multiple video bit streams accordingly. In the case when multiple video bit streams come from different content servers, the network node can take another commonly used approach. With this approach, the node equally divides the available bandwidth among multiple video sources. As an example, the node can allocate 2 Mbps for each of the two video sources for a total available bandwidth of 4 Mbps. Then the node informs the corresponding servers about the updated rate allocation, and each server in turn adjusts its sending video bit rate. One problem with the above approach is that it does not take the video content into account. Consequently the approach may lead to unfavorable viewing experience or suboptimal performance as explained below. For example, suppose a group of viewers who consume the video bit streams have a set of preferences about the video content, i.e., one content type is preferred over another. In this case, equally allocating the bandwidth among different video content types apparently does not satisfy the viewers' preference well.

When multiple bit streams are being received, the system may arbitrarily choose a video bit stream to adjust in order to optimize its bandwidth usage, but this practice can lead to suboptimal performance or cause unfavorable user viewing experience. It would be desirable for a network node to intelligently choose a video bit stream to adjust bit rate based on predetermined criteria. The invention described herein addresses this and/or other problems.

### SUMMARY OF THE INVENTION

In order to solve the problems described above, the present invention concerns an apparatus associated methods for receiving multiple streams of video content and providing it to network devices, as well as adaptively adjusting the bit rate of the video streams in response to a predetermined criteria. This and other aspects of the invention will be described in detail with reference to the accompanying Drawings.

In accordance with one aspect of the current invention a method is disclosed comprising the steps of receiving a first bit stream having a first bit rate, receiving a second bit stream having a second bit rate, determining a total bit rate of said first bit stream and said second bit stream, determining a first content of said first bit stream and a second content of said second bit stream in response to said total bit stream exceeding a threshold; and requesting an adjustment of said first bit rate of said first bit stream in response to determining that said first content has a lower priority than said second content.

Additional aspects of the present invention concern when the priority may be determined by at least one of a user, a service provider, and in response to a usage analysis.

In accordance with another aspect of the invention, an apparatus is disclosed wherein said apparatus comprises a source of a first bit stream, said first bit stream having a first bit rate, a source of a second bit stream, said second bit stream having a second bit rate, a processor for determining a first content of said first bit stream and a second content of said second bit stream in response to said total bit stream exceeding a threshold and requesting an adjustment of said first bit rate of said first bit stream in response to determining that said first content has a lower priority than said second content.

Additionally, the invention may comprise a method in response to when an adjustment of said first bit rate is requested in response to a network node having available bandwidth in order to increase the video quality of said first bit stream and said lower priority indicates a requirement for higher quality video.

Another aspect of the invention may include a method comprising the steps of receiving a first bit stream having a first bit rate, receiving a second bit stream having a second bit rate, determining a total bit rate of said first bit stream and said second bit stream, determining a first content of said first bit stream and a second content of said second bit stream in response to said total bit stream being less than a threshold, and requesting an adjustment of said first bit rate of said first bit stream in response to determining that said first content has a higher priority than said second content.
Another aspect of the invention may comprise an apparatus comprising a source of a first bit stream, said first bit stream having a first bit rate, a source of a second bit stream, said second bit stream having a second bit rate, a processor for determining a first content of said first bit stream and a second content of said second bit stream in response to said total bit stream being less than a threshold and requesting an adjustment of said first bit rate of said first bit stream in response to determining that said first content has a higher priority than said second content.
These and other aspects of the invention will be explained with reference to a preferred embodiment of the invention show in the accompanying drawings.

### DESCRIPTION OF THE DRAWINGS

The above-mentioned and other features and advantages of this invention, and the manner of attaining them, will become more apparent, and the invention will be better understood, by reference to the following description of embodiments of the invention taken in conjunction with the accompanying drawings, wherein:

FIG. 1 is a diagram of an embodiment of a system embodying aspects of the present invention;

FIG. 2 is a flow chart of an exemplary method according to the present invention;

FIG. 3 is a flow chart of an exemplary method according to the present invention;

The exemplifications set out herein illustrate preferred embodiments of the invention, and such exemplifications are not to be construed as limiting the scope of the invention in any manner.

### DETAILED DESCRIPTION

As described herein, the present invention provides an apparatus and associated methods for receiving compressed video content and adjusting the compression ratio of the content in response to available bandwidth of the network or a portion of the network, such as a network node or network gateway device. Furthermore the invention describes a high-level modification to facilitate the implementation of this functionality within an adaptive streaming application, recognizing the lack of support for this feature from many existing media transport formats,

In a network-based video streaming system, multiple video bit streams can share the bandwidth at some network node, e.g. a home gateway where multiple viewers in a house can watch different streaming video programs at the same time. When the aggregated full bit rate of these video bit streams exceeds the bandwidth capacity of the network node, network congestion can occur. On the other hand, when the aggregated bit rate is below the node's bandwidth capacity, the available resource is under-utilized. For an adaptive streaming system, both problems can be solved by dynamically changing the bit rates of some video sources. The question remains as how to choose the appropriate video source to adjust bit rate. Such a device may include advanced features, such as advanced user interfaces, the ability to receive and decoder content encoding in one of a plurality of coding formats, the ability to transmit requests onto a network in response to a bandwidth determination, as well as to receive web pages, audio content and other digital programming.

While this invention has been described as having a preferred design, the present invention can be further modified within the spirit and scope of this disclosure. This application is therefore intended to cover any variations, uses, or adaptations of the invention using its general principles. For example, while the primary embodiment described receives and processes video content, this invention may be applied to audio, data, or multimedia content with equally desirable results. Further, this application is intended to cover such departures from the present disclosure as come within known or customary practice in the art to which this invention pertains and which fall within the limits of the appended claims.

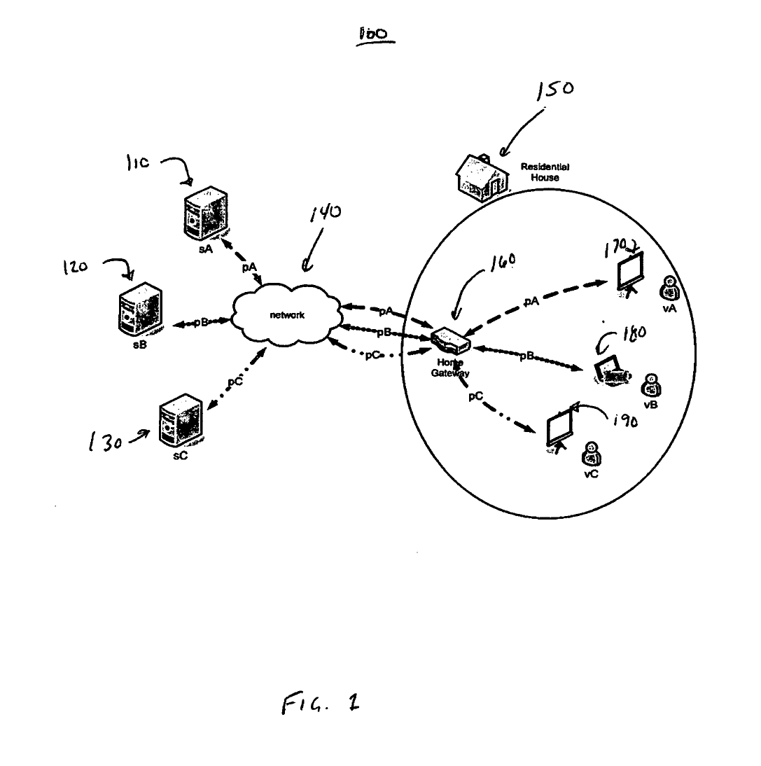

A diagram of an embodiment of a system embodying aspects of the present invention (100) is shown in FIG. 1. Turning to FIG. 1, an exemplary multistream video system (100) is shown. The system may receive a number of video streams (pA, pB, pC) from a number of servers (110, 120, 130). These video streams (pA, pB, pC) are transmitted over a network (140) to a home gateway (160). The home gateway (160) can operate as a gateway to a home network (150) and is operative to process and couple these program streams to a variety of devices, including televisions (170), personal computers (180), set top boxes (190), and other network enabled devices.

A home gateway (160) or similar device has a limited bandwidth, for example 4 mbit per second. Thus, ignoring overhead for this example, the home gateway is capable of receiving and routing 2, 2 mbit per second video bit streams (pA, pB). In the instance when a 3rd bit stream (pC) is requested, the home gateway (160) has no available bandwidth to process the 3^{rd} requested bit stream (pC). Thus, the home gateway (160) must request, for example, that server sB (120) begin providing a 1 mbit bit stream, so that the home gateway can receive a 1 mbit bit stream sC from server sC (130). However, instead of the system arbitrarily deciding which bit stream is reduced, a service provider or user may wish to prioritize which bit streams will start being received at a lower bit rate. For example, a user may wish to receive movies or sporting events at a higher bit rate, and therefore higher video quality, than news programming or children's programming. Additionally, a service provider may recognize that certain video content compresses better with less quality reduction than other types of content. For example, animated programs may compress better than sporting events.

The home gateway (160) can be a network router, a fiber optic multiplexer or the like. The home gateway is operative to receive a first video stream (pA) from the network (140) and a second video stream (pB) from the network. These video streams may be sent by the same server or different server. Video streams may originate from the same server provider or different service providers. The home gateway then determines the total bandwidth utilized by the first video stream and the second video stream. If the total bandwidth utilized is greater than the maximum bandwidth allowed, at least one of the bit rates of at least one of the signals must be reduced. The maximum bandwidth allowed can be a hard limit, such as the maximum bandwidth that can be facilitated by the home gateway (160), or it could be a soft limit, such as the maximum bandwidth allowed for video bit streams, leaving some available bandwidth for data, administrative, or auxiliary information. If the home gateway (160) determines that the maximum bandwidth has been exceeded, or would be exceeding if a bit stream was accepted, the home gateway (160) determines the content of the first bit stream and the content of the second bit stream. For example, the content of the first bit stream may be sports programming, and the content of the second bit stream may be animated programming. The home gateway compares each of these program types against a user defined priority list. The user creates a list where the types of programs are rated on a desirability scale. This indicates that a user wishes to receive certain program types in a higher resolution over other types when a bandwidth limit has been reached. In this example, a user has selected sports programming as a higher priority over animated programming. The home gateway (160) uses this information to determine that the second bit stream, carrying the animated programming, should be reduced in bit rate. The home gateway (160) sends a request to the server transmitting the second bit stream to reduce the bit rate of the second bit stream or to provide another version of the second bit stream with a lower bit rate. Alternatively, the server may be transmitting the program in a number of bit streams with different bit rates, and the home gateway (160) may just need to switch to a different bit stream carrying that program. The home gateway (160) may transmit the desired bitrate to the server, or the server may just step down the bit rate in predetermined increments.

Alternatively, a service provide may desire to scale certain types of programming over others. For example, a service provider may know from past experience that viewers describe an undesirable viewing experience when prime time network television or sporting events are scaled, as opposed to music programs or children's programming. In addition, the service provider may recognize that animated programming is easily compressed with little or no undesirable artifacts, where fast paced sport programming, such as ice hockey, does not compress easily and is subject to easily recognized artifacts. The service provider may provide a list of programming rankings to the home gateway (160), where the provided list is used to compare and request bit rate reductions or increases, according to criteria determined by the service provider.

In addition, the list may be automatically generated by the home gateway (160). The home gateway may examine the type of content being viewed over the home network and generate usage statistics. If a user watches considerably more movies that children's programming, the home gateway may assume that the user desires higher quality movie bit streams that that of children's programming. Thus, when a reduction of bit rate is required, children's programming has a lower priority than movies. This list may be altered or influenced by the user. For example, if a user is watching a certain program that has a lower priority, and the user desires a higher quality video, a user input can be received and the current programming will be moved higher on the priority list, either temporarily or permanently.

Different video content exhibit different characteristics in terms of compression “easiness”. More specifically, video sequences of different content types often require different compression bit rates in order to reach the same level of visual quality level. Hence assigning an equal bit rate to each video source by ignoring the characteristic difference between video content, some video sources may produce poor compression quality because of bit rate starvation, whereas other video sources may waste the assigned bit rate because of bit rate saturation. Therefore, the average visual quality across video bit streams is not optimized.

Considering again the exemplary embodiment as shown in FIG. 1, where in a residential house, three viewers vA, vB and vC are respectively watching streaming video programs pA, pB and pC at the same time. These video programs come from content servers sA, sB and sC and all simultaneously go through the home gateway (1600 node that resides within the house. Further assume that each content server is capable of adaptive streaming in that it can switch between different copies of encoded video bit streams of the same video content and stream out a version with the average bit rate that matches best to the requested network bit rate. If the video bit streams pA, pB and pC are being streamed to the gateway with a combined bit rate that exceeds or is below the gateway's bandwidth capacity, the gateway can selectively scale back or boost the bit rate of one or multiple video sources. It can do so by following two criteria:

In this case, the viewers instruct the gateway about their video content type preferences. For example, a possible preference list can be:

sports>movie>news>cartoon>sit-com

When such a viewer input is absent, the gateway can automatically build a preference list, possibly over time, by analyzing the viewers' viewing habits. For example, more watched content types are given higher preference.
With the preference list, the gateway node can select video sources for rate adjustment more intelligently.
a. When the available bandwidth is not sufficient, the node can first choose the video source with the least preferred content type to scale back its bit rate, followed by the next least one, and so on, until the bandwidth constraint is met.
b. When there is extra bandwidth, the node can first choose the video source that has the most preferred content type to increase its bit rate, followed by the next preferred one, and so on, until the available bandwidth is fully occupied.
   With the criterion, as a result, viewers can watch their favorable video content with the best possible quality given the available network resource. The user, or service provider, may also define a minimum bit rate for programming. In this instance, the lowest priority program is reduced to the minimum bit rate and the second lowest priority program's bit rate is reduced to meet the bandwidth requirements.
   Different video content exhibits different “easiness” to be compressed. Statistical multiplexing (Statmux) is a commonly used technique at the encoding stage to exploit this diversity, when multiple video sequences are encoded to have a combined constant bit rate. With Statmux, conceptually bit rate is allocated unevenly across video sequences according to their “easiness” measure, such that each time available bit rate is only given to the sequence that can most improve its visual quality. The coding gain thus obtained is often called “Statmux gain”. The Statmux principle can be similarly adopted by the gateway node to improve the overall (average) playback quality across all the video bit streams. If the gateway node has the knowledge about the “easiness” of each video bit stream at its current bit rate, then it can perform intelligent source selection.
a. When the available bandwidth is not sufficient, the node can choose the bit stream with the “easiest” level to scale back its bit rate, so that its quality is least affected by the amount of rate cut among all the sources. Each time the node follows this rule until the adjusted total bit rate is within its bandwidth capacity.
b. When there is extra bandwidth, the node can choose the bit stream with the “hardest” level to increase its bit rate, so that its quality improves the most among all the sources. Each time the node follows this rule until the available bandwidth is fully occupied.
   With the criterion, as a result, the average quality of all the video contents being watched by the viewers are optimized.

There are a number of ways for the network node to obtain the “easiness” information of a video bit stream: (1) At client side, where a video bit stream is fully parsed and decoded, such information is most conveniently available. So it is possible for the gateway node to collect the information from clients. (2) The gateway partially parses and analyses a video bit stream to get an estimate. (3) Content serve provides the information. It is worth noting that Statmux gains become bigger with a more diverse video content set. In the future, it is expected that more video content types will be deployed and thus coexist, for example, MPEG-2, H.264, SVC, MVC, UltraHD, etc. That will make the video content diversity larger, and in turn increases the Statmux gain in the use case. To support existing standards, a field could be added in a transport packet header that contains a value that indicates the rate vs. visual distortion ratio for the video bit stream at its current bit rate, where the video bit stream is carried by transport stream that the packet belongs to.

Another embodiment of the present invention may involve a virtual home gateway, wherein the administrative functions of the network are performed by at least one of the network enabled devices. For instance, a device may be receiving a video bit stream with errors indicating insufficient network bandwidth. These indications may include lost packets, delays, excessive buffering, or the like. The device may then pole the other network devices to determined if the other network devices are receiving video bit streams and at what bit rate and what content. The device may then compare this information to a priority list to determine which bit stream should be reduced. The device may then request that the server transmitting the lowest priority bit stream lower the bit rate of that bit stream. Alternately, the device may request that the other network device receiving the lower priority bit stream request the reduction from the server.

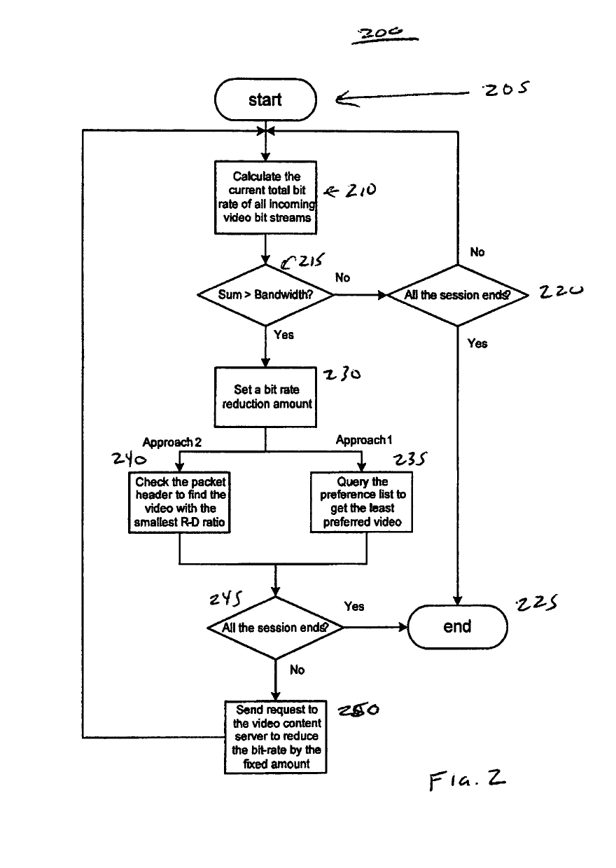

Turning to FIG. 2, an exemplary embodiment of the operation of the network node when its bandwidth is insufficient is shown (200). The subroutine commences after detecting at least one bit stream session (205). After the subroutine commences (205), and then calculates the current total bit rate of all incoming video bit streams (210), if the sum exceeds an available bandwidth (215), a bit rate reduction amount is determined (230). If the available bandwidth is not exceeded, the system determines if all streaming sessions have ended (220). If so, the subroutine ends (225), waiting for another bit stream session. If there remains at least one bit stream session, the subroutine returns to step (210). Once the bit rate reduction amount is determined, in one example, the system queries a preference list to determine the least preferred bit stream (235). In another example, the system checks the packet header to find the video with the smallest rate vs. visual distortion ratio 240 to determine the bit stream to be reduced (240). The subroutine then determines if all the video sessions have ended (245). If so, the subroutine ends (225), waiting for another bit stream session. If there remains at least one bit stream session, the subroutine sends a request to the video content server to reduce the bit rate of the selected bit stream by the calculated bit rate reduction amount (250). The subroutine then returns to step (210).

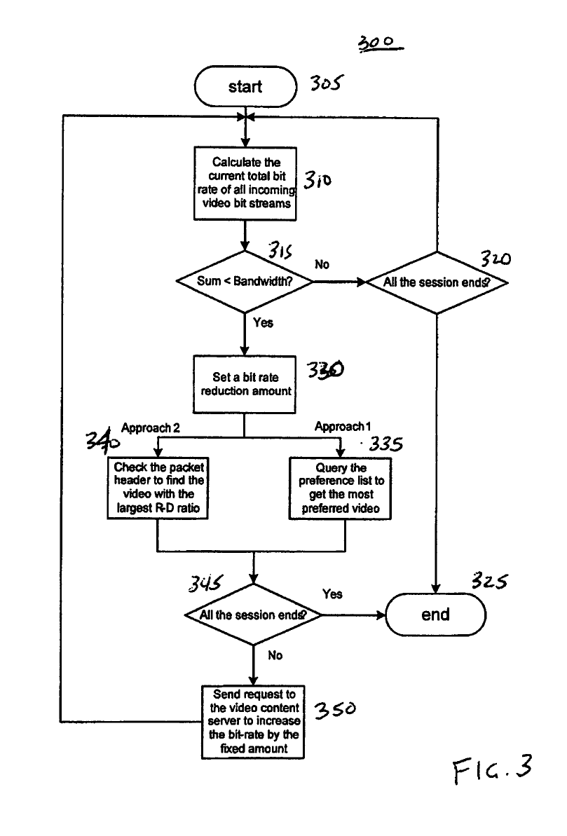

FIG. 3 shows the operations it follows when the network or network gateway has bandwidth surplus. Turning to FIG. 3, an exemplary embodiment of the operation of the network node when it has a bandwidth surplus is shown (300). The subroutine commences after detecting at least one bit stream session (305). After the subroutine commences (305), and then calculates the current total bit rate of all incoming video bit streams (310), if the sum is less than an available bandwidth threshold (315), a bit rate increase amount is determined (330). If the available bandwidth is not exceeded, the system determines if all streaming sessions have ended (320). If so, the subroutine ends (325), waiting for another bit stream session. If there remains at least one bit stream session, the subroutine returns to step (310). Once the bit rate increase amount is determined, in one example, the system queries a preference list to determine the most preferred bit stream (335). In another example, the system checks the packet header to find the video with the greatest rate vs. visual distortion ratio (340) to determine the bit stream to be increased (340). The subroutine then determines if all the video sessions have ended (345). If so, the subroutine ends (325), waiting for another bit stream session. If there remains at least one bit stream session, the subroutine sends a request to the video content server to reduce the bit rate of the selected bit stream by the calculated bit rate reduction amount (350). The subroutine then returns to step (310).

While the present invention has been described in terms of a specific embodiment, it will be appreciated that modifications may be made which will fall within the scope of the invention. For example, various processing steps may be implemented separately or combined, and may be implemented in general purpose or dedicated data processing hardware.

1. A method comprising the steps of:
receiving a first bit stream having a first bit rate;
receiving a second bit stream having a second bit rate;
determining a total bit rate of said first bit stream and said second bit stream;
determining a first content of said first bit stream and a second content of said second bit stream in response to said total bit stream exceeding a threshold; and
requesting an adjustment of said first bit rate of said first bit stream in response to determining that said first content has a lower priority than said second content.

2. The method of claim 1 wherein said priority is determined by a user.

3. The method of claim 1 wherein said priority is determined by a service provider.

4. The method of claim 1 wherein said priority is determined in response to a usage analysis.

5. The method of claim 1 further comprising the step of requesting a reduction of said second bit rate in response to said first bit rate reaching a minimum bit rate.

6. The method of claim 1 wherein said priority is determined in response to the quality of compression of the first content and the second content.

7. The method of claim 1 wherein said adjustment of said first bit rate is requested in response to a network node having available bandwidth in order to increase the video quality of said first bit stream.

8. An apparatus comprising:
a source of a first bit stream, said first bit stream having a first bit rate;
a source of a second bit stream, said second bit stream having a second bit rate;
a processor for determining a first content of said first bit stream and a second content of said second bit stream in response to said total bit stream exceeding a threshold and requesting an adjustment of said first bit rate of said first bit stream in response to determining that said first content has a lower priority than said second content.

9. The apparatus of claim 8 wherein said priority is determined by a user.

10. The apparatus of claim 8 wherein said priority is determined by a service provider.

11. The apparatus of claim 8 wherein said priority is determined in response to a usage analysis.

12. The apparatus of claim 8 further comprising the step of requesting a reduction of said second bit rate in response to said first bit rate reaching a minimum bit rate.

13. The apparatus of claim 8 wherein said priority is determined in response to the quality of compression of the first content and the second content.

14. The apparatus of claim 8 wherein said adjustment of said first bit rate is requested in response to a network node having available bandwidth in order to increase the video quality of said first bit stream and said lower priority indicates a requirement for higher quality video.

15. A method comprising the steps of:
receiving a first bit stream having a first bit rate;
receiving a second bit stream having a second bit rate;
determining a total bit rate of said first bit stream and said second bit stream;
determining a first content of said first bit stream and a second content of said second bit stream in response to said total bit stream being less than a threshold; and
requesting an adjustment of said first bit rate of said first bit stream in response to determining that said first content has a higher priority than said second content.

16. The method of claim 15 wherein said priority is determined by a user.

17. The method of claim 15 wherein said priority is determined by a service provider.

18. The method of claim 15 wherein said priority is determined in response to a usage analysis.

19. The method of claim 15 further comprising the step of requesting an increase of said second bit rate in response to said first bit rate reaching a maximum bit rate.

20. The method of claim 15 wherein said priority is determined in response to the quality of compression of the first content and the second content.

21. An apparatus comprising:
a source of a first bit stream, said first bit stream having a first bit rate;
a source of a second bit stream, said second bit stream having a second bit rate;
a processor for determining a first content of said first bit stream and a second content of said second bit stream in response to said total bit stream being less than a threshold and requesting an adjustment of said first bit rate of said first bit stream in response to determining that said first content has a higher priority than said second content.

22. The apparatus of claim 21 wherein said priority is determined by a user.

23. The apparatus of claim 21 wherein said priority is determined by a service provider.

24. The apparatus of claim 21 wherein said priority is determined in response to a usage analysis.

25. The apparatus of claim 21 further comprising the step of requesting an adjustment of said second bit rate in response to said first bit rate reaching a maximum bit rate.

26. The apparatus of claim 21 wherein said priority is determined in response to the quality of compression of the first content and the second content.

27. A method comprising the steps of:
receiving a first bit stream having a first bit rate, said first bit stream comprising a first content;
sending a request to receive an information indicating a second content on a second bit stream in response to an indication of a bandwidth deficiency;
receiving said information and indicating said second content; and
requesting an adjustment of said first bit rate of said first bit stream in response to determining that said first content has a higher priority than said second content.

28. An apparatus comprising:
a source of a first bit stream, said first bit stream having a first bit rate and comprising a first content;
a processor for sending a request to receive an information indicating a second content on a second bit stream in response to an indication of a bandwidth deficiency, receiving said information and indicating said second content, and requesting an adjustment of said first bit rate of said first bit stream in response to determining that said first content has a higher priority than said second content.
